(19) United States
(12) Patent Application Publication
(10) Pub. No.: US 2008/0112830 A1
(43) Pub. Date: May 15, 2008

(54) Autoclavable piston guide ring

(76) Inventors: Heiner Ophardt, Vineland (CA); Martin Anhuf, Kamp-Lintfort (DE)

Correspondence Address: RICHES, MCKENZIE & HERBERT, LLP, SUITE 1800, 2 BLOOR STREET EAST, TORONTO, ON, M4W 3J5, CA

(21) Appl. No.: 11/976,603

(22) Filed: Oct. 25, 2007

(30) Foreign Application Priority Data
Nov. 9, 2006 (CA) 2,567,670

(51) Int. Cl. B67D 5/42; B05B 11/00; F04B 7/00

(52) U.S. Cl. 417/547; 92/108

(57) ABSTRACT

A piston pump having a piston slidable within a cylindrical chamber, the piston carrying both a sealing flange to provide a slidable fluid impermeable seal with an inner wall of the chamber and a guide ring slidable in the chamber to assist in maintaining the sealing member coaxially within the chamber during autoclaving.

### SCOPE OF THE INVENTION

This invention relates to an improved guide ring for a piston pump and, more particularly, to a guide ring adapted to withstand autoclaving procedures to sterilize the pump.

### BACKGROUND OF THE INVENTION

Fluid dispensers are known with pump mechanisms which are to be subjected to autoclaving procedures for sterilization preferably on regular periodic intervals. Autoclaving requires subjecting the pump to elevated temperatures such as 120 degrees Celsius to 150 degrees Celsius for periods of time.

The present inventor has appreciated that many prior art pump mechanisms, after being subjected to autoclaving, often do not adequately pump fluid and believe that such degradation in pumping arises due to plastic seals becoming deformed during the autoclaving process.

### SUMMARY OF THE INVENTION

To at least partially overcome these disadvantages of previously known devices, the present invention provides a piston pump having a piston slidable within a cylindrical chamber, the piston carrying both a sealing flange to provide a slidable fluid impermeable seal with an inner wall of the chamber and a guide ring slidable in the chamber to assist in maintaining the sealing member coaxially within the chamber during autoclaving.

Accordingly, in one aspect, the present invention provides a pump for dispensing fluids from a reservoir comprising:

a piston-chamber forming member formed from metal having a cylindrical chamber about a central axis, said chamber having a chamber wall, an inner end in fluid communication with the reservoir and an open outer end;

the piston portion including a hollow stem with an inner portion coaxially slidably received in the chamber for reciprocal sliding inwardly and outwardly therein and with an outer portion extending outwardly of the open outer end of the chamber,

the stem defining therein a central passageway with an inner inlet end opening into the chamber and an outer end communicating with a discharge outlet on the outer portion of the stem out of the chamber,

a plastic annular sealing member fixedly secured to the inner end of the stem within the chamber axially spaced from the locating member,

the sealing member including an annular sealing flange slidably engaging an inner surface of the chamber wall forming a substantially fluid impermeable seal therewith on sliding of said piston forming element inwardly and outwardly,

the sealing member further including an annular locating flange spaced axially from the annular sealing flange slidably engaging the inner surface of the chamber wall over an axial extent sufficient to assist in resisting the annular sealing flange from assuming a non-coaxial position relative to the chamber during autoclaving treatment with the piston portion in the chamber and the locating member within the outer open end of the chamber under temperatures exceeding 120 degrees Celsius,

a central bore through the sealing member providing for the inlet opening of the passageway to be in communication with the reservoir through the sealing member.

In another aspect, the present invention provides a pump for dispensing fluids from a reservoir comprising:

a piston-chamber forming member formed from metal having a cylindrical chamber about a central axis, said chamber having a chamber wall, an inner end in fluid communication with the reservoir and an open outer end;

a piston forming element having a piston portion coaxially slidably received in the chamber, a locating member slidably engaged within the open outer end of the chamber to assist in coaxially locating the piston portion coaxially of the central axis and with an outer portion extending outwardly from the open outer end of the chamber,

the piston forming element including a generally cylindrical metal tube extending continuously inwardly from the outer portion through the locating member along the central axis and centrally through the piston portion,

the tube defining therein a central passageway with an inner end opening into the chamber and an outer end communicating with a discharge outlet on the outer portion,

a plastic piston sealing member within the chamber fixedly secured to the inner end of the tube,

the sealing member including:

(a) at an outer end, an outwardly directed cylindrical socket to frictionally engage the inner end of the tube coaxially therein;

(b) at an inner end, an annular sealing flange slidably engaging an inner surface of the chamber wall forming a substantially fluid impermeable seal therewith on sliding of said piston forming element inwardly and outwardly, and

(c) an annular locating flange spaced axially from the annular sealing flange slidably engaging the inner surface of the chamber wall over an axial extent sufficient to assist in resisting the annular sealing flange from assuming a non-coaxial position relative to the chamber during autoclaving treatment with the piston portion in the chamber and the locating member within the outer open end of the chamber under temperatures exceeding 120 degrees Celsius, and

(d) a central bore through the annular sealing flange and the locating flange communicating with the socket for communication of fluid to the inner end of the tube.

An object of the present invention is to provide a sealing member on the inner end of a piston element received in a metal cylindrical chamber forming member which maintains a seal after autoclaving.

### BRIEF DESCRIPTION OF THE DRAWINGS

Further aspects and advantages of the present invention will become apparent from the following description taken together with the accompanying drawings in which:

FIG. 1 is a schematic side view of a pump mechanism in accordance with a first preferred embodiment of the present invention;

FIG. 2 is an enlarged view of a portion of FIG. 1; and

FIG. 3 is a further enlarged view of a portion of FIG. 1.

### DETAILED DESCRIPTION OF THE DRAWINGS

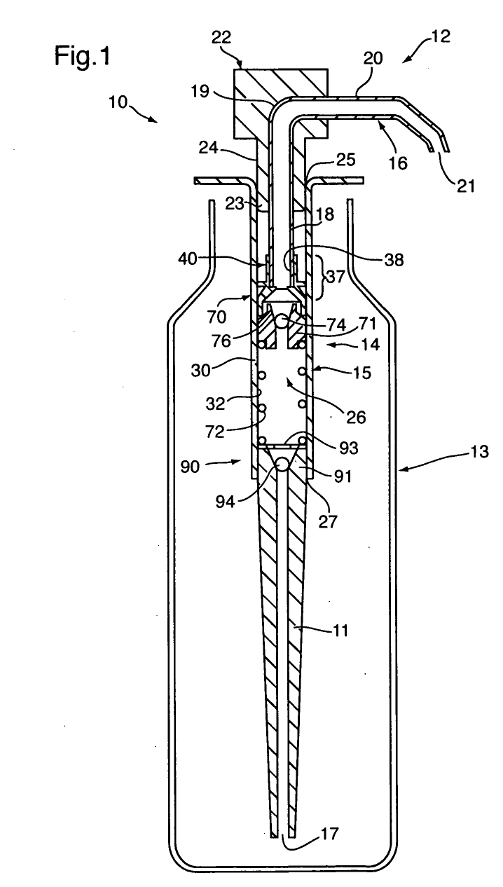

FIG. 1 shows a pump mechanism 10 comprising a piston element 12 and a piston chamber forming member 14 disposed relative a reservoir bottle 13 for dispensing fluid from the bottle 13. The piston element 12 includes a metal tube 16 having a vertical portion 18, a curved portion 19 and a horizontal portion 20 ending at a discharge outlet 21. The piston element 12 includes a casing member 22 about the upper end of the vertical portion 18 of the tube and the curved portion 19. The casing member 22 has a locating portion 23 with external cylindrical guide surfaces 24 to guide the upper end of the vertical portion 18 of the tube 16 coaxially within the piston chamber forming member 14.

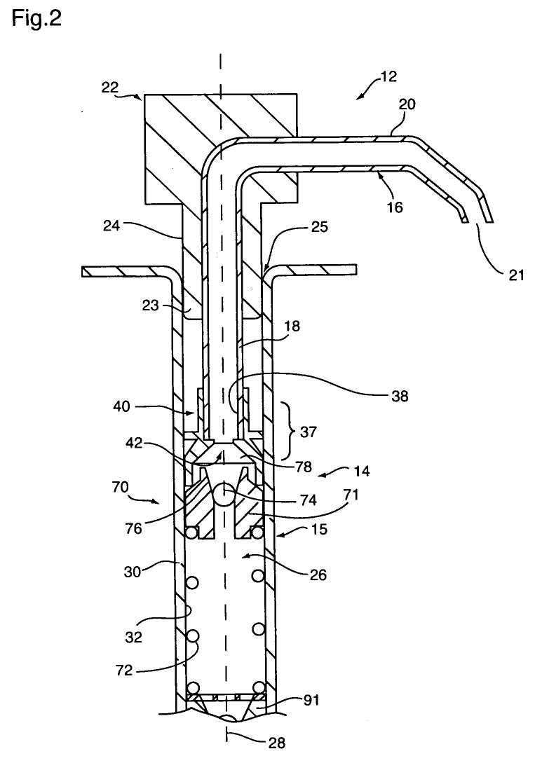

The piston chamber forming member 14 is formed from metal and has a metal cylinder 15 defining therein a cylindrical chamber 26 about a central axis 28 shown on FIG. 2. The chamber 26 has a chamber wall 30 with an inner surface 32. The chamber 26 is open at an upper, outer end 25 and open at a lower, inner end 27. A hollow dip tube 11 extends downwardly from the inner end 27 of the chamber 26 to an inlet end 17 in communication with the reservoir bottle 13.

The piston element 12 includes an inner portion 37 at a lower end 38 of the tube 16 where a plastic annular sealing member 40 fixedly secured to the tube 16. The sealing member 40 is secured to the lower end of the tube 16 and provides a central bore 42 therethrough for fluid flow from a lower inner end of the sealing member 40 through the sealing member 40 and into the open lower end 38 of the tube 16. The sealing member 40 includes (a) an axially upwardly directed socket 44 for fixed, sealed engagement with the lower end 38 of tube 16, (b) a locating ring 46 for slidably locating the sealing member coaxially within the chamber 26, and (c) an annular sealing flange 48 to engage the inner surface 32 of the chamber wall 30 forming a substantially fluid impermeable seal therewith on sliding of the piston forming element inwardly and outwardly. The bore 42 extends through the sealing member 40 centrally through the socket 44, the annular locating ring 46 and the annular sealing flange 48.

The sealing member 40 has the tube receiving socket 44 formed with an upper tubular portion 50, an open upper outer end 52 and a cylindrical inner side wall 54 ending inwardly at an annular radially inwardly extending shoulder 56. A lower end 38 of the tube 16 is frictionally and sealably received inside the cylindrical inner side wall 54 of the socket 44 abutting on the shoulder 56. While not necessary, one or more radially inwardly extending ribs (not shown) may be provided on the inner side wall 54 of the tubular portion 50 of the socket 44 to ensure frictional and sealed engagement against removal of the tube 16 or fluid flow therepast.

The locating ring 46 is an annular ring which extends radially outwardly about the socket 44 and presents a cylindrical outer surface 58 sized to coaxially slide within the chamber 26 without creating any substantial resistance to sliding. The cylindrical outer surface 58 extends an axial extent indicated as A. This axial extent is selected to assist in maintaining the sealing member 40 coaxially within the cylindrical chamber 26 against tilting to assume a non-coaxial orientation relative to the chamber, particularly, during autoclaving treatment.

The sealing flange 48 extends axially downwardly from below the shoulder 56 about the bore 42, firstly as a conical portion 60 having both inner side wall surfaces 62 and outer side wall surfaces 64 frustoconical tapering axially downwardly and radially outwardly. The lower narrowed end 67 of the conical portion 60 merges into an axially extending annular sealing flange portion 68 having a generally cylindrical outer surface and a generally cylindrical inner surface. The sealing member 40 is made from a plastic material and the sealing flange 48 is sized such that the sealing flange portion 68 is inherently biased due to the resiliency of the plastic into engagement with the cylindrical inner surface 32 of the chamber wall 30 to prevent fluid flow in either direction therepast.

The locating ring 46 shown has an axial extent A about ⅙ of a diameter D of the chamber 26. The axial extent A is, preferably, at least ⅛ of the diameter D and, more preferably, at least ⅙, ⅕ or ¼ of the diameter D. The pump mechanism 10 shown is adapted for autoclaving with the piston element 12 received within the piston chamber forming element 14. Autoclaving is to be carried out under elevated temperatures for periods of time, preferably, with the temperatures to be in the range, for example, of at least 110 degrees Celsius, or at least 120 degrees Celsius or at least 150 degrees Celsius. When autoclaving occurs under these elevated temperatures, the metal cylinder 15 expands greater than the plastic sealing member 40 with the result that the plastic sealing member 40 becomes loose within the metal cylinder 15 and the piston element 14 is free to adopt an angled orientation, that is, out of coaxial alignment with the central axis 28. When autoclaving is finished, the piston element 12 has a tendency to remain in the angled orientation such that on cooling to ambient temperatures, the metal cylinder 15 shrinks onto and compresses the angled sealing flange portion 68 confining it to adopt an oval cross-sectional shape when viewed normal to the central axis 28. The annular sealing flange portion 68 tends to maintain this oval cross-sectional shape after cooling and, in later use, on sliding of the piston element 12 coaxially in the chamber 26 forms an inferior seal with the inner surface 32 of the chamber wall 30 of the chamber than a preferred shape of the annular sealing flange portion 68, that is, a shape which is circular in cross-section normal the central axis 28.

The locating ring 46 assists in reducing the ability of the annular sealing flange 48 to adopt a configuration that is not coaxial with the central axis 28. The locating ring 46, in having its cylindrical outer surface of a radial size only marginally smaller than the radius of the chamber wall 32 and in having a substantially axial extent A of at least ⅛ of the diameter of the chamber 26 will, at all times, be capable of engaging the inner surface 32 of the chamber wall 30 of the chamber 26 to limit the extent to which the sealing member 40 may be tilted to a non-axial orientation. Limiting the extent to which the sealing member 40 can assume at an angled orientation will limit the extent to which the sealing flange may be deformed into an oval cross-sectional shape.

The locating ring 46 preferably has as large a diameter as possible without causing significant friction against sliding within the chamber wall 30. Preferably, the locating ring 46 has a diameter only marginally smaller than the diameter of the chamber 26, for example, preferably at least 99% of the diameter of the chamber, more preferably, at least 99.5% or 99.9% of the diameter of the chamber.

The piston forming element 12 may be considered to have a hollow stem including the tube 16 with an inner portion 37 comprising the inner end 38 of the tube 16 with the sealing member 40 thereon and with an outer portion 23 comprising the locating portion 23 of the casing member 22 with the external cylindrical guide surfaces 24 in the open end of the chamber 26. The inner portion 37 has the locating ring 46 assisting coaxial location within the chamber 26. The outer portion 23 has the guide surfaces 24 assisting coaxial location within the chamber 26. The inner portion 37 and outer portion 23 are axially spaced enhancing the ability of the axially spaced locating ring 46 and the guide surfaces 24 when received in the chamber 26 to cooperatively assist in coaxial location of the piston element 12 generally and the sealing flange 48 specifically coaxially within the chamber 26 before, during and after autoclaving.

The pump mechanism 10 has inward of the sealing member 40 an outer ball valve 70 and an inner ball valve 90 each providing for one way flow outwardly therepast but preventing flow inwardly therepast.

An inner ball valve seat member 91 of the inner ball valve 90 is fixedly secured in the inner end 27 of the chamber 26. The dip tube 11 is shown as an integral extension of the inner valve seat member 90. A ball cage member 93 is engaged above, outwardly of the inner ball valve seat member 91, and serves to retain a ball 94 above the inner ball valve seat member 91 yet permits fluid flow centrally therethrough.

A helical coil spring 72 has an inner end engage the ball cage member 93 urging it inwardly into the inner ball valve seat member 91. An outer end of the spring 72 engages on an outer ball valve seat member 71 of the upper outer ball valve 70 resiliently resisting inward, downward movement of the outer ball valve seat member 71.

The annular outer ball valve seat member 71 is slidable in the chamber 26 and biased axially upwardly outwardly into engagement with the sealing member 40 by the coil spring 72. A ball 74 for the outer ball valve 70 is received inside the upwardly opening frustoconical valve seat surface 76 to provide a one-way valve mechanism against fluid flow downwardly and inwardly therepast yet permit fluid flow upwardly and outwardly. The sealing member 40 has on the inner side surfaces 62 of the conical portion 60 at least one axially and radially inwardly extending vane 78 defining radial and axial passageways on either side therepast. The vane 78, when engaged by the ball 74, does not prevent fluid flow. The vane 78 assists in keeping the ball 74 in a position above the ball valve seat surface member 71.

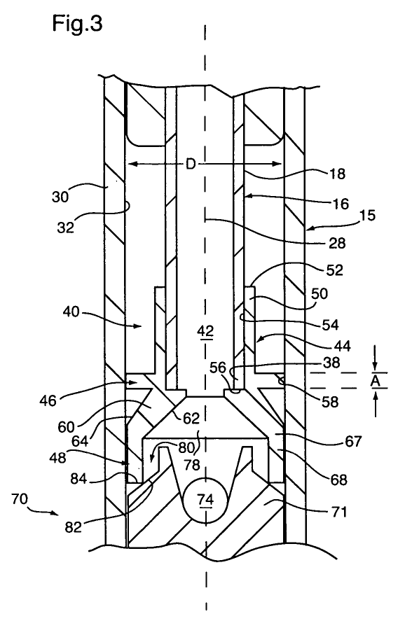

As seen in FIG. 3, the ball valve seat member 71 has at its radially outermost surface at its upper outer end, an annular groove 80 ending at an inner end as a cam shoulder 82 which is angled to extend radially outwardly and axially inwardly for engagement with an inner end 84 of the annular sealing flange portion 68 to urge, under the bias of the spring 72, the sealing flange portion 68 radially outwardly into sealed engagement with the chamber wall 30.

Movement of the piston element 12 axially inwardly to a retracted position relative the piston chamber forming member 14 urges the sealing member 40 into the outer ball valve seat member 71 compressing the spring 72. On release of the piston element 12, the spring 72 biases the piston element 12 to return to an extended position. Reciprocal movement of the piston element 12 draws fluid from the reservoir in the inner end 17 of the dip tube 11 through the dip tube 11, through the inner end 27 of the chamber 26 through the tube 16 and dispenses it out the discharge outlet 21 of the tube 16.

While the invention has been described with reference to preferred embodiments, many modifications and variations will now occur to a person skilled in the art. For a definition of the invention, reference is made to the following claims.

We claim:

1. A pump for dispensing fluids from a reservoir comprising:
a piston-chamber forming member formed from metal having a cylindrical chamber about a central axis, said chamber having a chamber wall, an inner end in fluid communication with the reservoir and an open outer end;
a piston forming element having a piston portion coaxially slidably received in the chamber,
the piston portion including a hollow stem with an inner portion coaxially slidably received in the chamber for reciprocal sliding inwardly and outwardly therein and with an outer portion extending outwardly of the open outer end of the chamber, the stem defining therein a central passageway with an inner inlet end opening into the chamber and an outer end communicating with a discharge outlet on the outer portion of the stem out of the chamber,
a plastic annular sealing member fixedly secured to the inner end of the stem within the chamber,
the sealing member including an annular sealing flange slidably engaging an inner surface of the chamber wall forming a substantially fluid impermeable seal therewith on sliding of said piston forming element inwardly and outwardly, the sealing member further including an annular locating flange spaced axially from the annular sealing flange slidably engaging the inner surface of the chamber wall over an axial extent sufficient to assist in resisting the annular sealing flange from assuming a non-coaxial position relative to the chamber during autoclaving treatment with the piston portion in the chamber and the locating member within the outer open end of the chamber under temperatures exceeding 120 degrees Celsius,
a central bore through the sealing member providing for the inlet opening of the passageway to be in communication with the reservoir through the sealing member.

2. A pump as claimed in claim 1 wherein the annular locating flange slidably engages the inner surface of the chamber wall over an axial extent at least equal to ⅛ of a diameter of the chamber.

3. A pump as claimed in claim 1 wherein the annular locating flange slidably engages the inner surface of the chamber wall over an axial extent at least equal to ⅙ of a diameter of the chamber.

4. A pump as claimed in claim 1 including a locating member fixedly carried on the stem slidably engaged within the chamber proximate the open outer end of the chamber to assist in coaxially locating the stem coaxially of the central axis.

5. A pump as claimed in claim 1 wherein the stem includes a generally cylindrical metal tube extending continuously inwardly from the outer portion through the locating member along the central axis to an inner end of the tube which is coaxially received in an outwardly directed cylindrical socket provided on an outer end of the sealing member.

6. A pump as claimed in claim 5 wherein in the outer portion the metal tube is bent so as to form an extension of the tube extending generally radially outwardly from the central axis to the discharge outlet.

7. A pump as claimed in claim 1 including,
an inlet one-way valve between the reservoir and the chamber permitting fluid flow through the inner end of said chamber only from the reservoir to the chamber;
an outlet one-way valve between the chamber and the annular sealing flange permitting fluid flow through the central bore only from the chamber into the passageway,
wherein in operation,
(i) on the piston forming element sliding outwardly in said chamber a vacuum is created in the chamber which closes the outlet one-way valve and fluid is drawn into the chamber from the reservoir past the inlet one-way valve, and
(ii) on the piston forming element sliding inwardly into the chamber a pressure is created in the chamber which closes the inlet one-way valve and fluid is discharged from the chamber past the outlet one-way valve through the central bore, into the inlet end of the passageway and the discharge outlet.

8. A pump as claimed in claim 3 wherein the diameter of the annular locating flange is at least 99% of the diameter of the chamber.

9. A pump for dispensing fluids from a reservoir comprising:
a piston-chamber forming member formed from metal having a cylindrical chamber about a central axis, said chamber having a chamber wall, an inner end in fluid communication with the reservoir and an open outer end;
a piston forming element having a piston portion coaxially slidably received in the chamber, a locating member slidably engaged within the open outer end of the chamber to assist in coaxially locating the piston portion coaxially of the central axis and with an outer portion extending outwardly from the open end of the chamber,
the piston forming element including a generally cylindrical metal tube extending continuously inwardly from the outer portion through the locating member along the central axis and centrally through the piston portion,
the tube defining therein a central passageway with an inner end opening into the chamber and an outer end communicating with a discharge outlet on the outer portion,
a plastic piston sealing member within the chamber fixedly secured to the inner end of the tube,
the sealing member including:
(a) at an outer end, an outwardly directed cylindrical socket to frictionally engage the inner end of the tube coaxially therein;
(b) at an inner end, an annular sealing flange slidably engaging an inner surface of the chamber wall forming a substantially fluid impermeable seal therewith on sliding of said piston forming element inwardly and outwardly, and
(c) an annular locating flange spaced axially from the annular sealing flange slidably engaging the inner surface of the chamber wall over an axial extent sufficient to assist in resisting the annular sealing flange from assuming a non-coaxial position relative to the chamber during autoclaving treatment with the piston portion in the chamber and the locating member within the outer open end of the chamber under temperatures exceeding 120 degrees Celsius, and
(d) a central bore through the annular sealing flange and the locating flange communicating with the socket for communication of fluid to the inner end of the tube.

10. A pump as claimed in claim 9 wherein the annular locating flange slidably engages the inner surface of the chamber wall over an axial extent at least equal to ⅛ of a diameter of the chamber.

11. A pump as claimed in claim 9 wherein the annular locating flange slidably engages the inner surface of the chamber wall over an axial extent at least equal to ⅙ of a diameter of the chamber.

12. A pump as claimed in claim 9 wherein in the outer portion the metal tube bends so as to form an extension of the tube extending generally radially outwardly from the central axis to the discharge outlet.

13. A pump as claimed in claim 9 including:
an inlet one-way valve between the reservoir and the chamber permitting fluid flow through the inner end of said chamber only from the reservoir to the chamber;
an outlet one-way valve between the chamber and the annular sealing flange permitting fluid flow through the central bore only from the chamber into the passageway,
wherein in operation,
(i) on the piston forming element sliding outwardly in said chamber fluid a vacuum is created in the chamber which closes the outlet one-way valve and fluid is drawn into the chamber from the reservoir past the inlet one-way valve, and
(ii) on the piston forming element sliding inwardly into the chamber a pressure is created in the chamber which closes the inlet one-way valve and fluid is discharged from the chamber past the outlet one-way valve through the central bore into the inlet end of the passageway and the discharge outlet.
